(19) United States
(12) Patent Application Publication
(10) Pub. No.: US 2013/0103449 A1
(43) Pub. Date: Apr. 25, 2013

(54) System and Method for Optimization of Vehicle Reconditioning Cycle Time

(71) Applicants: John Dennis McGinn, Palo Alto, CA (US); Lowell Schneider, Alameda, CA (US)

(72) Inventors: John Dennis McGinn, Palo Alto, CA (US); Lowell Schneider, Alameda, CA (US)

(21) Appl. No.: 13/660,275

(22) Filed: Oct. 25, 2012

Related U.S. Application Data
(60) Provisional application No. 61/551,253, filed on Oct. 25, 2011.

(51) Int. Cl. G06Q 10/06

(52) U.S. Cl. 705/7.15

(57) ABSTRACT

A method and system is disclosed for measuring and managing the continuous reconditioning cycle-time of used vehicles and similar used electromechanical equipment. The system includes a central computer, having a database for storing vehicle data and vehicle status, that is accessible by any computing device that is connected to the Internet, including smart phones, laptop computers, personal computers and tablet computers. The system also provides management reporting analytics for reconditioning cycle time performance monitoring and bottleneck/problem visibility.

### CROSS-REFERENCE TO RELATED APPLICATIONS

This application claims the benefit of U.S. provisional application No. 61/551,253, filed 25 Oct. 2011, which is hereby incorporated by reference as though fully set forth herein.

### BACKGROUND OF THE INVENTION

a. Field of the Invention

The instant invention relates to preparation of commodities, such as vehicles, for sale and/or resale. In particular, the instant invention relates to systems and methods for optimizing the process of conditioning and/or reconditioning such commodities for sale and/or resale.

b. Background Art

Many commodities go through a conditioning or reconditioning process as part of preparing such commodities for sale and/or resale. For example, when a new car is received by an auto dealership, it must be prepared (e.g., removal of shipping cocoons and other protective packing material) prior to being placed on the lot or in the showroom for sale. New vehicles may also need to be periodically removed from the lot or showroom to be refreshed. Likewise, dealerships typically recondition used cars before placing them on the lot or in the showroom in an effort to obtain the best possible resale price.

By way of further explanation, FIG. 1 illustrates reconditioning steps that an auto dealership may use to recondition a used vehicle for resale. As shown in FIG. 1, the reconditioning cycle for a used car typically starts in block 102 when a pre-owned vehicle is taken in trade, purchased at auction, purchased from a car rental company, returned off a lease, or otherwise in transit to the dealership. After the vehicle is received at the dealership, it is typically inspected by one or more qualified mechanics or technicians (block 104), and a detailed condition report is prepared (block 106).

In block 108, the condition report is used to create a repair order listing work that may be necessary and/or desirable to recondition the used vehicle for resale. The repair order is typically presented to a manager for approval (block 110). The manager decides which repairs to effect, based on market factors such as a competitive on-line price for the particular vehicle and a target profit. For example, the manager may decide to effect certain repairs and forego others, because the cost of effecting a certain repair would far exceed the expected increase in resale price.

Following managerial approval, reconditioning work takes place in block 112. This work can include any number of services, such as, by way of example only, mechanical repairs (block 112a), body shop work (e.g., paint and dent repairs) (block 112b), subcontracted work (e.g., glass repairs, interior repairs, wheel and tire repairs) (block 112c), detailing (block 112d), and the like.

Once all reconditioning steps are completed, photos are typically taken (block 114) and the vehicle is ready for sale (block 116).

Of course, pre-owned vehicles have widely varying reconditioning needs in order to bring them up to dealers' and/or manufacturers' standards for resale. If the used car is to be resold as “certified,” where the manufacturer backs the warranty, the reconditioning process can be even more extensive. Thus, the steps outlined above and illustrated in FIG. 1 may differ from dealership to dealership, or even from car to car. One salient characteristic of extant reconditioning processes, however, is that the various steps are conducted seriatim—that is, a vehicle must move through the “Mechanical & Parts” step before moving to the “Body Shop” step.

Market forces, such as accessibility to most vehicles for sale through Internet sites such as AutoTrader.com, Cars.com, and Google, have significantly reduced the amount of time a dealership has to sell a vehicle in order to realize a profit. This is further influenced by the fact that buyers are willing to travel great distances to save even small amounts of money when purchasing a new or used car. In short, the reconditioning cycle time needed to make a profit has been compressed from months or weeks to days. Indeed, in some major markets, a vehicle may need to be sold at a loss at auction if not purchased inside of three weeks from the time it enters dealer inventory. Put another way, the importance of minimizing the reconditioning cycle time has increased because of Internet access to information regarding used cars and the increased consumer awareness of buyers to the best price.

As shown in FIG. 1, and as the ordinarily skilled artisan will recognize, extant used vehicle reconditioning process flows are typically linear. This serial process presents scheduling challenges. For example, vehicles can become backed up due to a lack of availability of the personnel required at any given step (e.g., a lack of mechanics may cause a backlog of vehicles in the mechanical stage, while detailers, required at a later stage of the process, sit idle). The required personnel may also be assigned customer-paid work (block 118) (e.g., a customer brings his or her car to repair accident damage in the body shop, as shown in FIG. 1), and such work often takes priority, thereby disturbing the used vehicle reconditioning workflow. These bottlenecks and delays quickly damage a dealer's bottom line.

Moreover, because the technicians performing the reconditioning services are typically paid by job rather than by time, their interests are inherently in conflict with the need of the dealership to optimize or minimize reconditioning cycle time. That is, technicians often have an incentive to compress the time it takes to complete a given job in order to maximize the number of jobs they can perform, and thereby maximize their income. This haste can lead to mistakes and the need to repeat reconditioning steps. This tension can further adversely affect the dealership's profit.

Current systems also fail to provide a real-time, transparent environment where the reconditioning process can be optimized. Instead, current systems for tracking vehicles through the reconditioning process typically consist of shared spreadsheets or whiteboards that are manually updated and lack individual and collective accountability. These manual processes are subject to abuse, prone to error, and do not provide the ability to respond to changing supply, changing customer demand, or the availability of resources (e.g., mechanics, detailers) involved in producing a sale-ready pre-owned vehicle. Any person-to-person communication or expediting of particular vehicles requires additional effort and added time, and thus reduces profitability.

### BRIEF SUMMARY OF THE INVENTION

It is therefore desirable to provide a fast, efficient, and flexible system that ensures accountability for every employee and vendor involved in the vehicle reconditioning process, while simultaneously and continuously minimizing the average reconditioning cycle time for all vehicles in view of changing supply and demand (e.g., which vehicles in the reconditioning process are needed most urgently on the lot as indicated by monitoring web page views for specific and high demand vehicles).

It is also desirable to provide a system that adds transparency and accountability to the vehicle reconditioning process, for example by providing reporting capabilities, thereby allowing dealership management to allocate and adjust resources such that the reconditioning workflow operates with maximum efficiency.

It is an object of the present invention to provide a system and method for vehicle conditioning and/or reconditioning that allows for a series of dealer-defined steps, unconstrained by the serial progression of work to be completed at each step. Desirably, any Internet-connected device (e.g., computer, mobile phone, smart phone, tablet) can be used to access a view of all vehicles in the reconditioning process, their current step, and their progress in real-time, including the time elapsed at each step.

It is another object of the present invention to provide a system and method for vehicle conditioning and/or reconditioning that provides additional accountability and transparency relative to extant vehicle conditioning and/or reconditioning systems and methods.

In certain aspects, the present invention includes an on-line system and method that provides increased transparency to users and a process automation system that facilitates the completion of reconditioning steps in the minimum, most efficient cycle time. In another aspect, the present invention provides automated alerts (e.g., color, text, and/or email alerts) for every handoff in the reconditioning process (that is, alerts when a vehicle moves from one step to the next). Advantageously, the present invention enables simple, one-click task to move a vehicle forward in the reconditioning process, to skip steps in the process to maximize the use of available resources, or to send a vehicle back to prior steps in the process if needed. As such, the present invention provides a level of visibility (transparency), flexibility, accountability, and control that is not possible with traditional systems.

Various subsystems may be provided to facilitate the reconditioning process, which may include importing of individual vehicle descriptions and other information from a dealer management system, minimizing time between reconditioning steps, effectively and efficiently completing each step from receiving a vehicle to having the respective vehicle available to sell, and the like.

Also provided to support the phases of the reconditioning process are additional tools, which may be integrated into the system. The additional tools may include self-management subsystems, reconditioning management subsystems and training subsystems.

Disclosed herein is a method of optimizing cycle time for a process of preparing vehicles for sale. The method includes: defining a plurality of steps in a process of preparing vehicles for sale, the plurality of steps including an initial step, at least two intermediate steps, and a final step; establishing an electronic database having a plurality of records, wherein each record comprises vehicle identification data and data regarding progress of the respective vehicle through the plurality of steps; assigning a first vehicle to the initial step; and moving the first vehicle to a first intermediate step based upon one or more of customer demand for the first vehicle, supply, and resources available to execute each of the at least two intermediate steps.

Optionally, the method includes generating and delivering an electronic alert message when the first vehicle is moved from the initial step to the first intermediate step.

Preferably, the first vehicle is moved from the first intermediate step to a second intermediate step based upon one or more of customer demand for the first vehicle, supply, and resources available to execute each of the at least two intermediate steps. It is also contemplated that an electronic alert message can be generated and delivered when the first vehicle is moved from the first intermediate step to the second intermediate step.

In general, the method can include moving the first vehicle from the first intermediate step in the plurality of steps to all other intermediate steps in the at least two intermediate steps based upon one or more of customer demand for the first vehicle, supply, and resources available to execute each of the at least two intermediate steps.

For optimization, an electronic alert can be generated and delivered if the first vehicle remains in the first intermediate step longer than a threshold duration.

In another aspect, a method of optimizing cycle time for a process of preparing vehicles for sale includes the steps of: defining a plurality of steps in a process of preparing vehicles for sale; establishing an electronic database having a plurality of records, wherein each record comprises vehicle identification data and data regarding progress of the respective vehicle through the plurality of steps; performing the plurality of steps upon a vehicle, wherein an order in which the plurality of steps are performed is based upon one or more of customer demand for the vehicle, supply, and resources available to execute each step within the plurality of steps.

The present invention reduces the complexity of current reconditioning systems and processes and creates a natural flow. At each dealer-defined step, all the owners of that step know exactly what cars they are responsible for and how long they have been at that step. Further, the total cycle time for all cars for any date range is visible to all users, along with their individual step performance. The present invention also enables dealership managers to proactively address potentially problematic process or resource constraints by providing them with automated reports of vehicle status, resource availability, and the like.

An advantage of the present invention is that it allows the reconditioning process to be optimized based on changing vehicle supply, changing market demand, and resource availability.

Another advantage of the present invention is that it fosters individual accountability and effects a desirable change in behavior from the current system, which is prone to employee conflicts due to lack of clear and timely visibility into the progress of vehicles in reconditioning as a shared measure to minimize the average reconditioning cycle time.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a flowchart depicting a representative serial used vehicle reconditioning process.

FIG. 2 is a flowchart depicting a representative used vehicle reconditioning process according to the present invention.

FIG. 3 illustrates various aspects of the present invention in connection with a vehicle reconditioning process, including the generation of reports, analytics, and other metrics viewed on and/or delivered to various electronic devices.

FIG. 4 is a sample screen shot depicting a summary report for a vehicle reconditioning process according to the teachings herein including sixteen user-defined steps.

FIG. 5 is a sample screen shot depicting performance metrics for a vehicle reconditioning process according to the teachings herein.

FIG. 6 is a sample screen shot depicting summary performance metrics for a vehicle reconditioning process according to the teachings herein.

FIG. 7 depicts a representative staff report showing all authorized users with titles and text and email addresses.

FIG. 8 shows an illustrative real-time reconditioning report, including the use of colors to identify vehicle status.

FIG. 9 shows the by-step thresholds and recipients for the color alerts depicted in FIG. 8.

### DETAILED DESCRIPTION OF THE INVENTION

The present invention provides systems and methods for conditioning and/or reconditioning articles of commerce for sale and/or resale. Preferably, the various processes described herein are implemented using one or more computer processors running on one or more computer systems, thereby establishing a computerized system and method for the present invention. That is, the methods described herein may be executed by one or more computer systems, and may be software implemented (e.g., one or more software programs executed by one or more computer systems or processors), hardware implemented (e.g., a series of instructions stored in one or more solid state devices), or a combination of both. The computer may be a conventional general purpose computer, a distributed computer, or any other type of computer. Further, the computer may comprise one or more processors, such as a single central processing unit or a plurality of processing units, commonly referred to as a parallel processing environment. The term “processor” as used herein refers to a computer microprocessor and/or a software program (e.g., a software module or separate program) that is designed to be executed by one or more microprocessors running on one or more computer systems.

The systems and methods disclosed herein can be employed to good advantage to condition and/or recondition (or “prepare”) any article of commerce with a volume sale and/or resale market. For purposes of illustration, however, and without intending to limit the generality of the present teachings, the invention will be described in connection with preparing vehicles for resale in the used vehicle market through a reconditioning process. The ordinarily skilled artisan will appreciate how to extend the teachings herein to other contexts (e.g., preparing new vehicles for initial sale, refreshing new vehicles that have been on the lot a predetermined amount of time) or other articles of commerce (e.g., reconditioning used electronics, such as cellular telephones or computers, for resale).

Used car dealers now have at their fingertips the market data needed to acquire the best cars for their location and the price can they can charge to make a profit. Armed with this information, they seek to acquire these cars at the right price, recondition them, and get them online, on the lot, in the showroom, and otherwise available for resale in the shortest time practicable.

The Internet levels the playing field for buyers, however. Buyers now have the advantage of additional information and many more choices than before the advent of the Internet.

Thus, in order to stay profitable, a dealer must turn over its inventory in about 30 to 45 days. This need for speed has created an emerging need for the automation of the reconditioning process such that, once a used car is in hand and evaluated, it travels quickly through all the necessary steps to make it saleable at the right, Internet-driven price. To achieve maximum velocity through the reconditioning process, given constantly changing demand, supply, and available resources, the path that any given car takes between dealership receipt and ready for sale must be made more flexible than extant systems and methods allow.

For example, if a car needs paint and body shop work, which typically takes from 3 to 5 days complete, and capacity is available in the dealer's body shop, cars can be routed there immediately, rather than only going for paint and body shop work according to a serialized procedure that may result in cars arriving at the body shop when no capacity is available. This is also true for mechanical work and subcontracted work. Similarly, steps such as detailing and photos, which are historically the last steps before the car is placed online, can be done first to start the sales process. The present invention facilitates this flexibility for any number of steps and any number of cars. Put simply, the present invention allows used cars to be routed through the reconditioning process according to supply, demand, and available resources, including allowing steps to occur “out of order,” rather than requiring cars to adhere to a rigid, serialized process that may result in backlogs in certain steps and idle resources at others. The present invention also provides advantageous flexibility for dealing with customer-paid work.

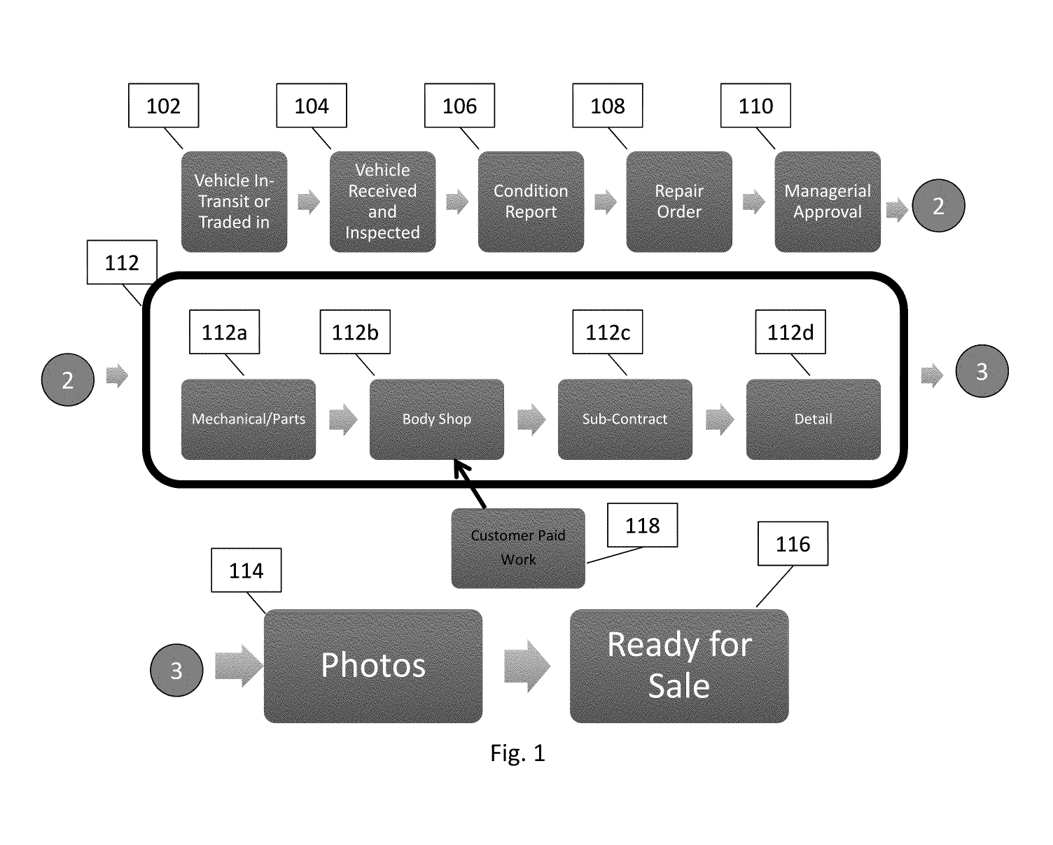

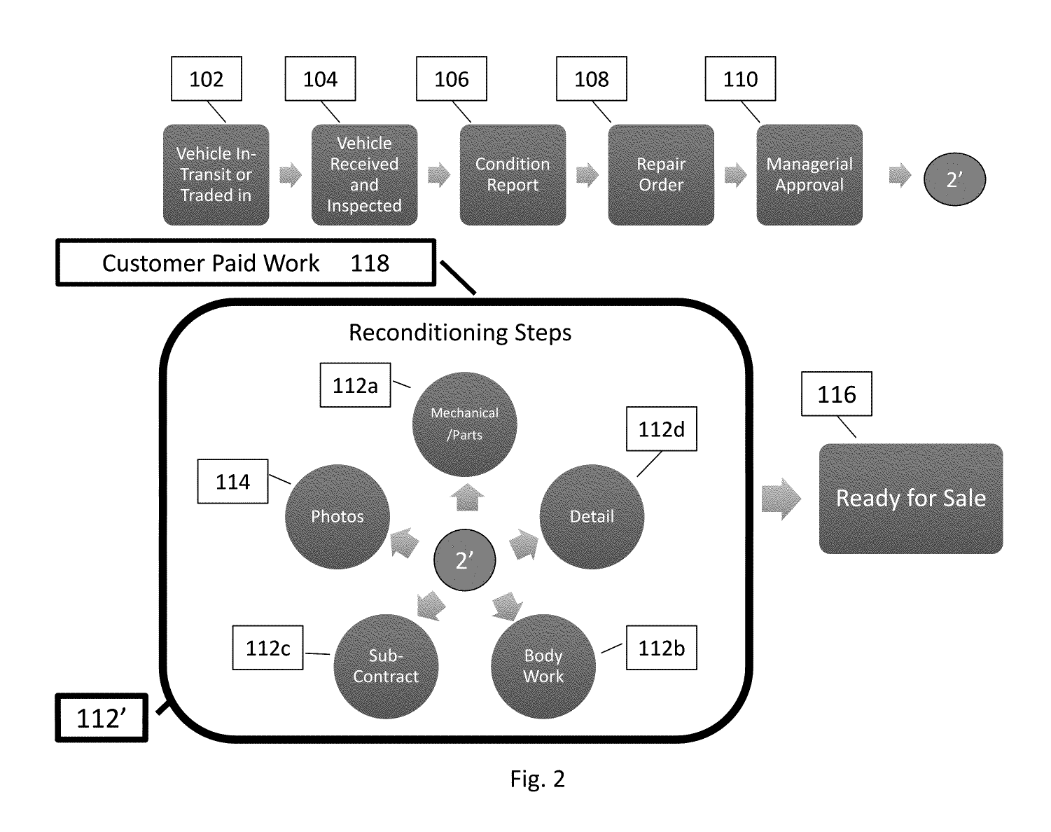

FIG. 2 is a flowchart that depicts steps that may occur in a used vehicle reconditioning process according to the present invention. For the sake of clarity, and to aid in understanding the differences between the present invention and extant reconditioning processes, the steps of the reconditioning process illustrated in FIG. 2 are identical to those in FIG. 1. It is within the spirit and scope of the present invention, however, to define more or fewer steps depending on the needs or desires of a particular dealership. Indeed, an embodiment of the inventive process with additional user-defined steps is described infra.

The first several steps of this process, from “Vehicle In-Transit or Traded In” through “Managerial Approval,” are common with extant reconditioning processes. Likewise, the inventive reconditioning process depicted in FIG. 2 ends with the vehicle in the same “Ready for Sale” state as extant reconditioning processes.

The inventive reconditioning process differs substantially from extant reconditioning processes in that the reconditioning work that takes place within block 112′ (e.g., mechanical/parts work, body shop work, sub-contracted work, detail work, and photo work) need not be serialized. That is, a vehicle undergoing the inventive reconditioning process can be routed or re-routed to any step within block 112′ at any time, and in any order, subject to factors such as customer demand, supply, and resource availability, rather than according to a rigid, serialized process. Incoming customer paid work 118 can be similarly routed and re-routed.

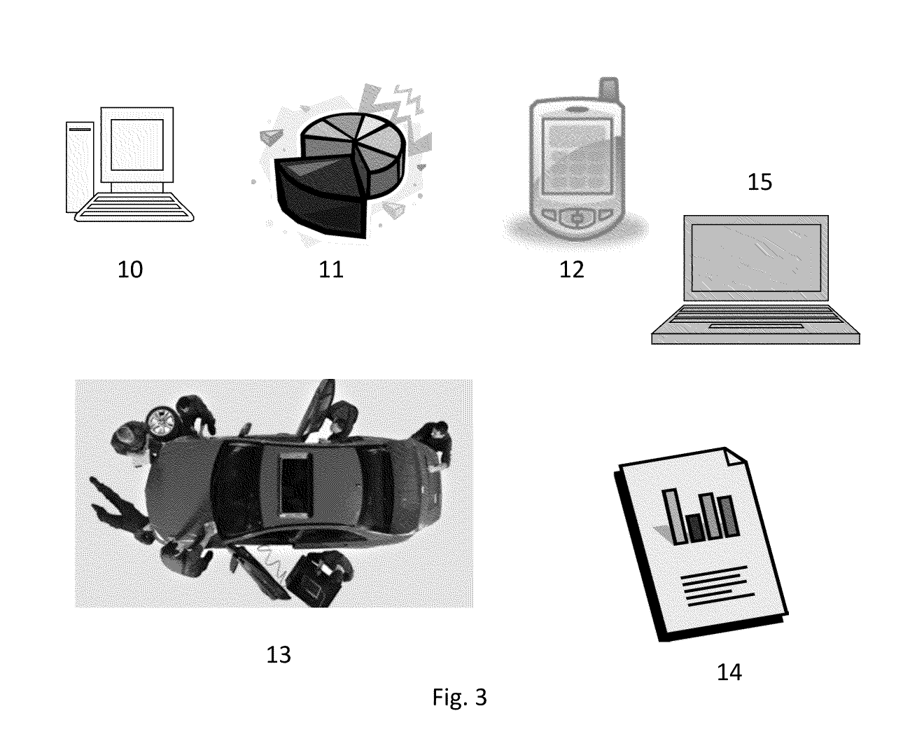

Another advantage of the present invention is that it provides improved visibility to dealership personnel (e.g., management) as to the status of any given vehicle within the reconditioning process, and thus improves accountability of the technicians and other employees actually performing the reconditioning work. Various aspects of this improved visibility are illustrated in FIG. 3.

For example, it is contemplated that managers (or other designated personnel) will receive an electronic alert (e.g., a text message, an email, or the like) when a particular step in the reconditioning process is complete (e.g., body shop work completed). The manager can then route the vehicle to a subsequent step (e.g., to a contractor for interior repair) based on factors such as supply, demand, and resource availability. Alerts may also be generated if a vehicle spends longer than a pre-designated amount of time in a particular step (e.g., if the vehicle remains in the body shop step longer than 5 days), or in the reconditioning process generally, thereby allowing the manager to follow-up with the assigned technicians or take other appropriate corrective action and/or mitigating steps.

In addition to electronic alerts, the present invention also enables dealership personnel (e.g., management) to generate and/or receive pre-defined and/or on-demand reports 14, metrics 11, and other analytics regarding the reconditioning process and the performance of personnel involved therein. For example, a manager may wish to see how long a given vehicle 13 has been in the mechanical and parts phase of the reconditioning process as an objective measure of the performance of the assigned technician. Alternatively, a manager may wish to query the average time vehicles spend in detailing as an objective measure of the overall performance of the dealerships detailing operations. These reports can be viewed on-line (e.g., on a laptop 15 or desktop computer 10) or off-line (e.g., printed out), and can also be delivered (e.g., via e-mail) to a mobile device 12, such as a cellular phone or tablet.

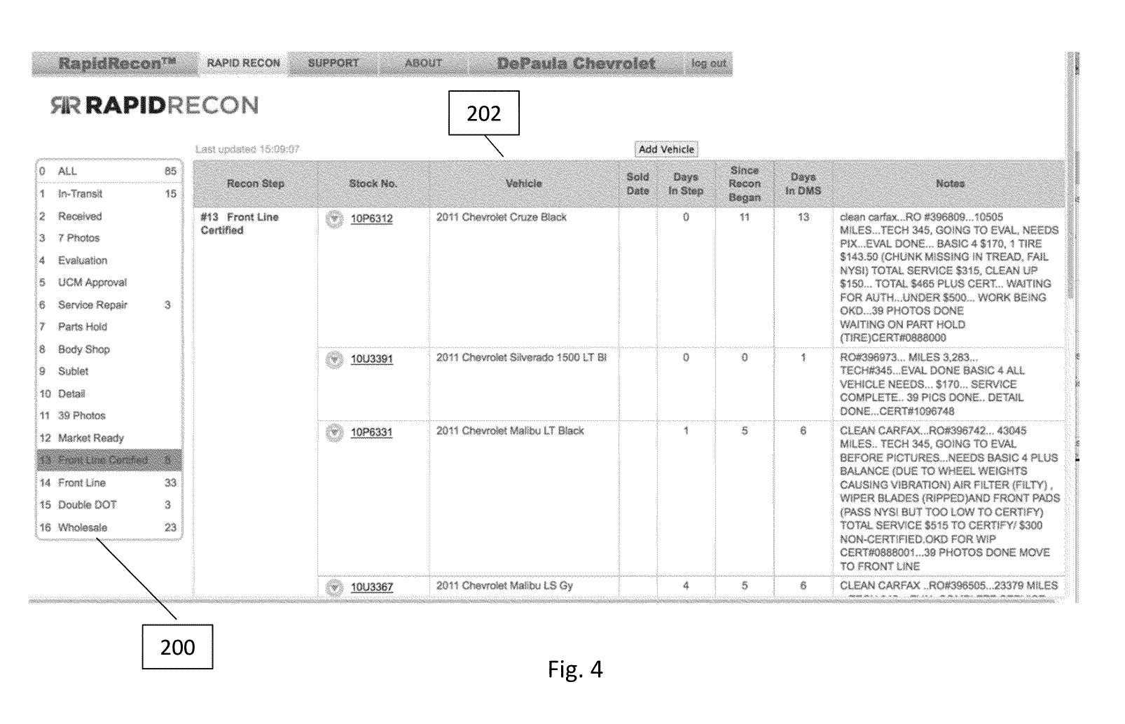

FIGS. 4 through 9 are representative screen shots of various aspects of the present invention. FIG. 4, for example, is a summary report for a Chevrolet dealership. Panel 200 shows that the reconditioning process has been divided into sixteen user-defined steps: In-Transit; Received; 7 Photos; Evaluation; UCM Approval; Service Repair; Parts Hold' Body Shop; Sublet; Detail; 39 Photos; Market Ready; Front Line Certified; Front Line; Double DOT; and Wholesale. Shown next to each step is the number of vehicles currently assigned to that step (e.g., there are 3 vehicles in the Service Repair step). Panel 202 is a portion of a report regarding the 8 vehicles in the Front Line Certified step, including information regarding the number of days that each vehicle has been in the Front Line Certified step, the number of days that each vehicle has been in the reconditioning process, and the number of days the vehicle has been owned by the dealer under the column “Days in DMS,” where “DMS” stands for Dealer Management System. The difference between the “Days in DMS” and “Days in Recon” column, if any, would typically correspond to the number of days the vehicle spent in transit to the dealer (e.g., the number of days between vehicle data being entered into the dealership's inventory management and/or accounting systems and when the vehicle actually arrived at the dealership and was inspected and placed into the reconditioning process.

FIG. 4 also depicts a “Notes” field for each vehicle. As a result of its flexibility (e.g., the dealership can include any information not otherwise captured by the system in this field), this field offers a number of advantages. For example, the dealership can require that the Notes field include a history of problems found with a vehicle during initial inspection (e.g., step 104), a record of repairs made and repairs that dealer management elected not to make, reconditioning costs, approvals (e.g., by whom and when), and any other pertinent or desirable information. Indeed, the Notes field can be detailed enough to provide a snapshot of a vehicle's history similar to the CARFAX® vehicle history reports available from Carfax, Inc.

Moreover, data within the Notes field can be mined for other beneficial purposes. For example, if the Notes field is used to track reconditioning costs, this information can be extracted and used to generate a report of typical reconditioning costs by year, make, and model of vehicle. No such report currently exists because vehicle reconditioning processes lack the requisite transparency to gather such data. This, in turn, can drive the price a dealership is willing to pay to acquire a used vehicle, offering a further competitive advantage to dealerships that utilize the inventive system and method disclosed herein.

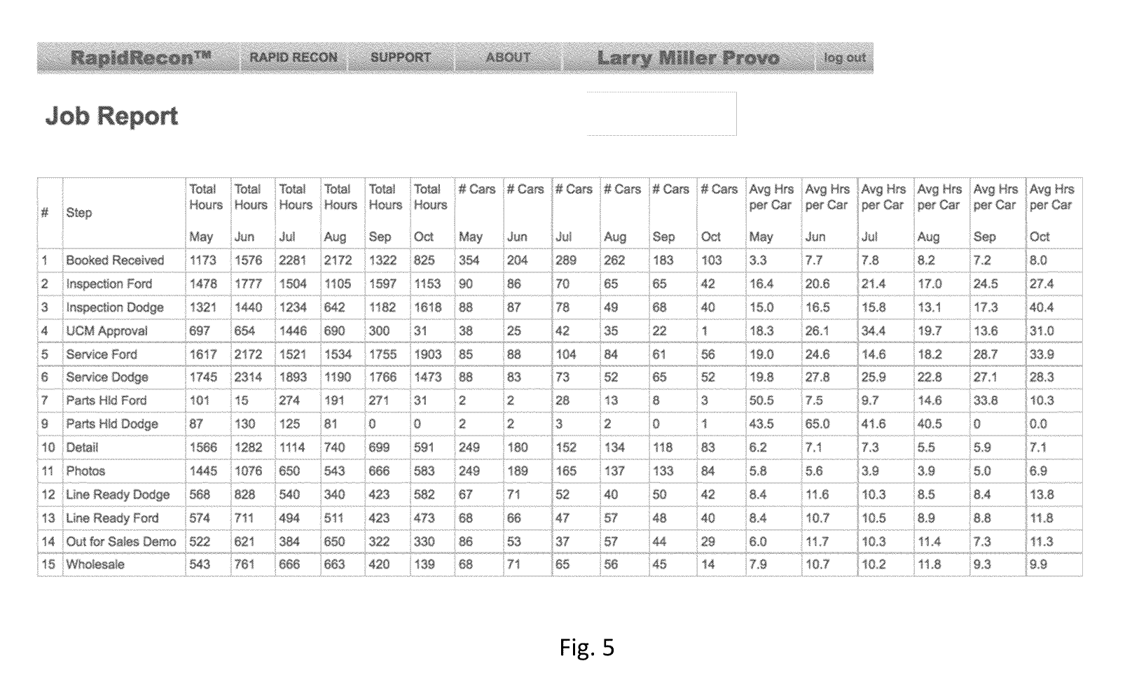

FIG. 5 is a report of various reconditioning process metrics. These metrics include the number of hours vehicles spent in each step on a monthly basis, the number of vehicles handled in each step on a monthly basis, and the average number of hours each vehicle spent in each step on a monthly basis.

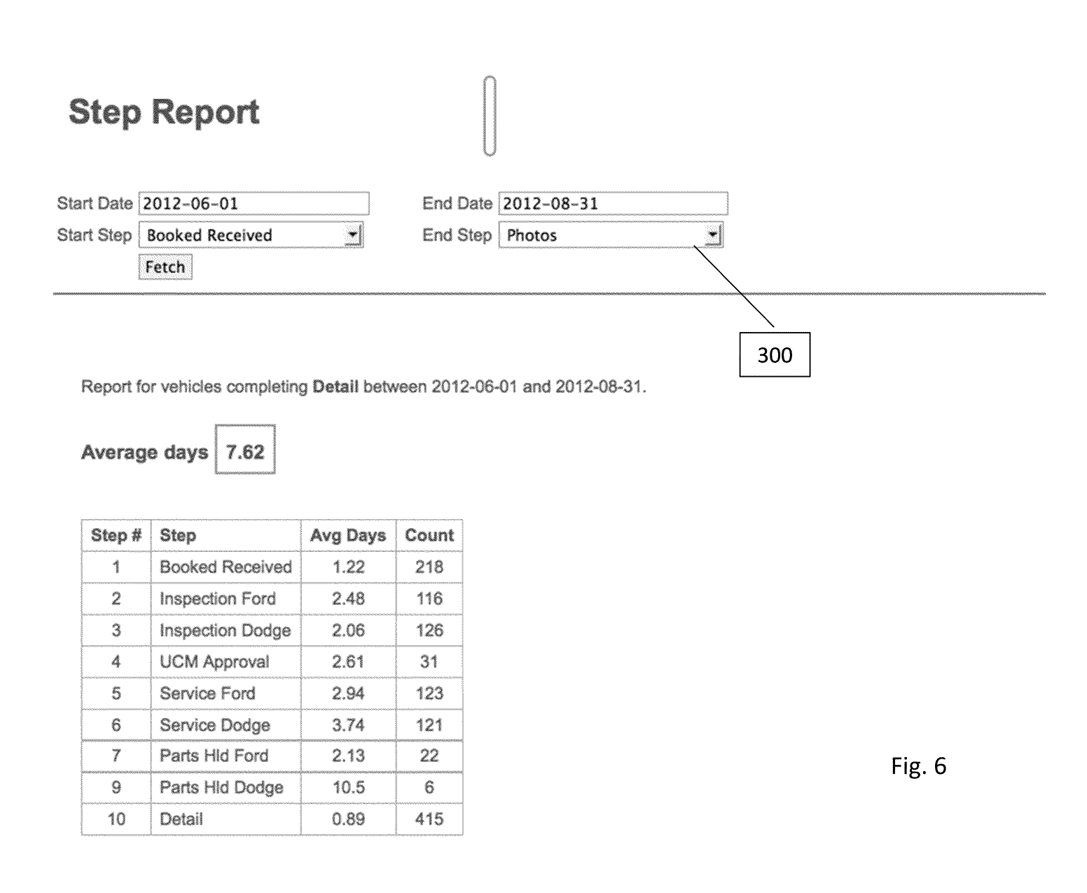

FIG. 6 is a report of the average cycle times and number of vehicles for various steps. As shown in FIG. 6, for the three month period from June to August 2012, inclusive, the average vehicle completed the ten user-defined steps (i.e., Booked Received; Inspection Ford; Inspection Dodge; UCM Approval; Service Ford; Service Dodge; Parts Hld Ford; Parts Hld Dodge; and Detail) (advantageously, not necessarily in that order) in 7.62 days. Search fields 300 allow the user to specify date ranges and step ranges.

Of course, reports of additional metrics and analytics are within the spirit and scope of the invention (e.g., week-to-week or month-to-month, rather than quarter-to-quarter, comparisons).

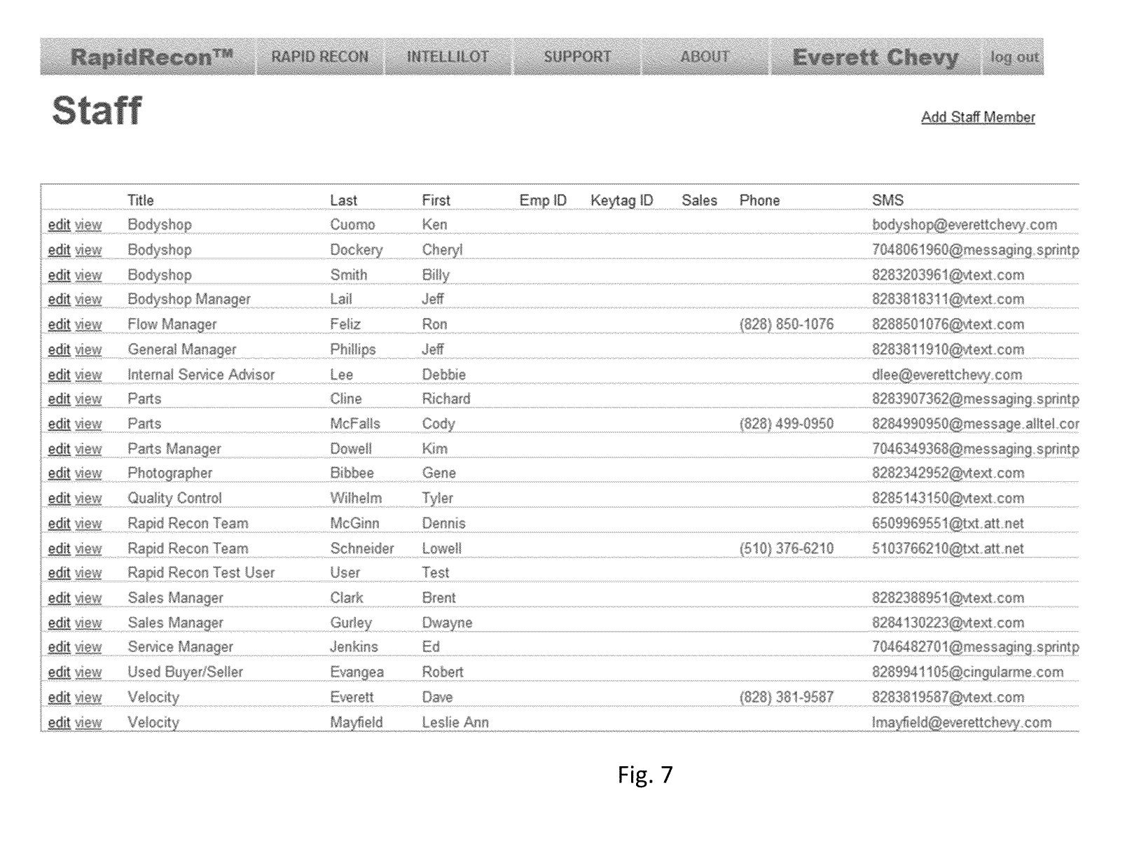

FIG. 7 shows all system users. In this screen, users can be added and deleted by the dealer's system administrator. This is also where text and email addresses are entered for purposes of alerting the relevant users when a car is moved to (or, in some embodiments of the invention, from) their step. The creation of system user account credentials and the assignment of roles, privileges, and the like to various system users will be familiar to the ordinarily skilled artisan and need not be further described herein.

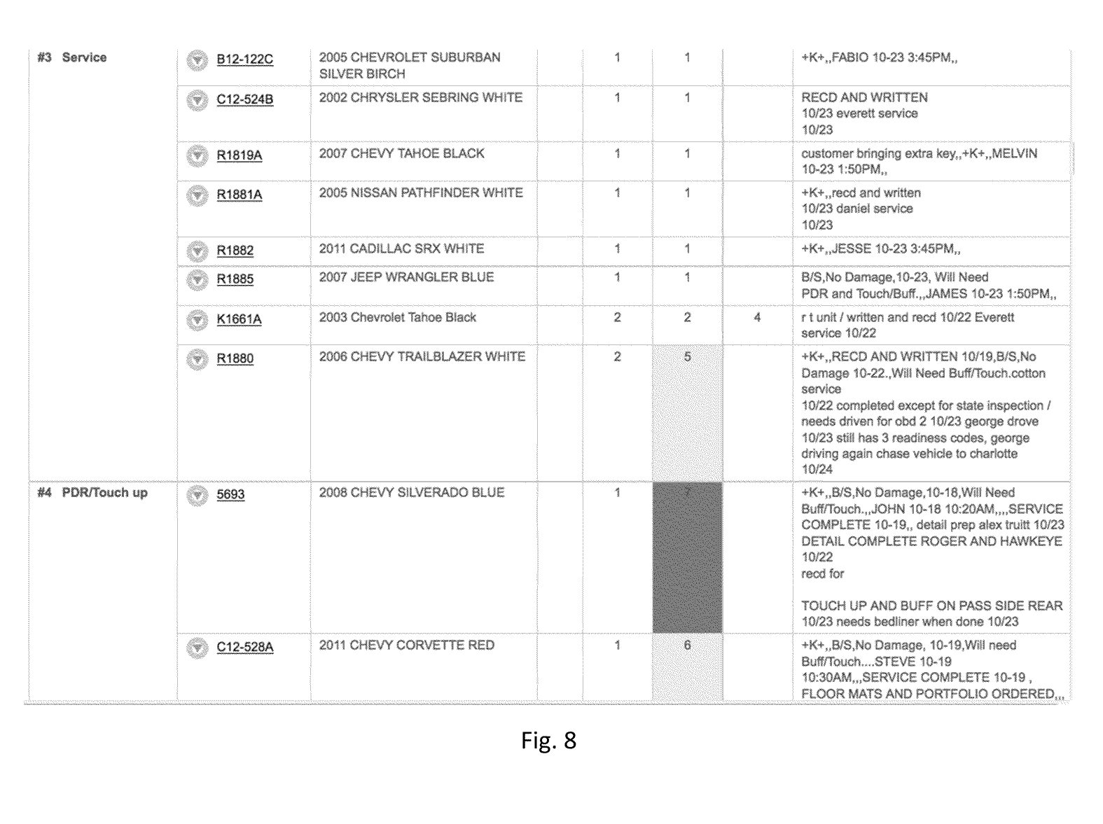

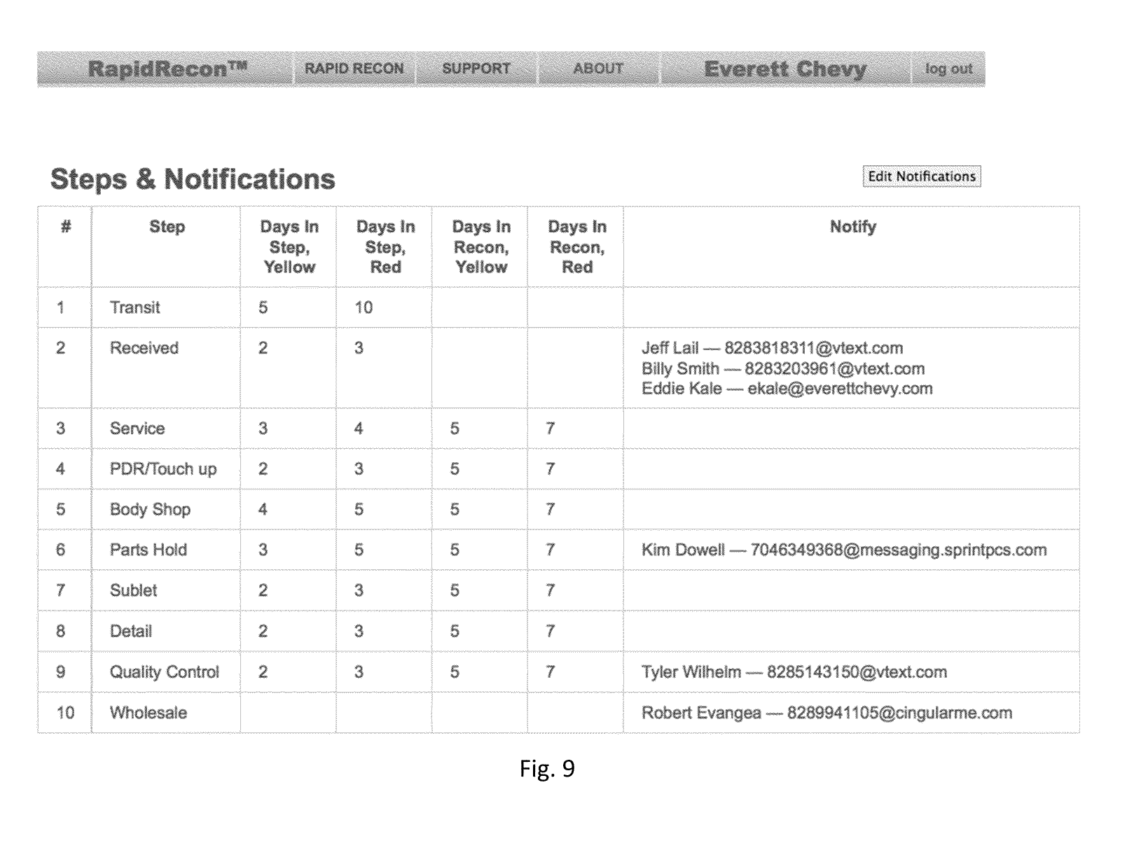

FIG. 8 shows the use of color alerts in a report to highlight cars that are taking more time in a given step and/or more time in reconditioning overall than what the dealer is willing to accept, as based on thresholds that the dealer can designate. For example, yellow (shown as light shading) can be used to indicate a warning of an impending unacceptable delay, while red (shown as darker shading) indicates the occurrence of unacceptable delay. The threshold for these alerts can be seen in FIG. 9. FIG. 9 also shows the setup of who is alerted at each step by text or email in the event a threshold is exceeded.

The General Manager (“GM”) of a dealership is overall responsible for the performance of the dealership. Thus, the GM has a strong incentive to address issues, such as non-optimized processes and resource shortages, that can adversely impact the vehicle reconditioning process. Doing so after-the-fact, however, is not optimal. Thus, the color alerts depicted in FIG. 8 provide an early warning, enabling GM's to be proactive to address issues, for example by making additional resources available or, alternatively, to remove the vehicle from the reconditioning process and instead sell it wholesale at auction.

Those of ordinary skill in the art will recognize that there are many reasons a vehicle can be delayed during reconditioning, including waiting on parts, waiting on warranty approvals, and waiting on paperwork (e.g., to clear title). The present invention advantageously provides dealership GMs (and other dealership personnel) with real-time information to enable more logical decision-making (e.g., reallocate resources or dispose of the vehicle at auction), better evaluation of subordinates (e.g., allowing the GM to assess the quality of the used car manager's decisions), and long-term process improvements (e.g., to allocate more resources to certain phases of the reconditioning process and to remove resources from others).

For example, suppose a dealership takes a car in trade, and that, in step 104, hidden body damage is discovered that would require the vehicle's frame to be straightened. This would delay the vehicle's progress and would generate an alert that would allow the GM to act and, if necessary, overrule the decisions of the used car manager.

Although several embodiments of this invention have been described above with a certain degree of particularity, those skilled in the art could make numerous alterations to the disclosed embodiments without departing from the spirit or scope of this invention.

For example, it is within the spirit and scope of the present invention to include additional and/or different fields in management reports generated by the inventive system. These fields can include fields dedicated to information described above in connection with the “Notes” field.

As another example, the present invention can be utilized to track estimated reconditioning cost vs. actual reconditioning cost, either in the “Notes” field or in one or more dedicated fields. It is also contemplated that periodic reports of the actual costs can be furnished, for example to the dealership's GM, so as to provide the GM with additional and/or better information on which to make decisions regarding the disposition of vehicles within inventory.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of optimizing cycle time for a process of preparing vehicles for sale, comprising:
defining a plurality of steps in a process of preparing vehicles for sale, the plurality of steps including an initial step, at least two intermediate steps, and a final step;
establishing an electronic database having a plurality of records, wherein each record comprises vehicle identification data and data regarding progress of the respective vehicle through the plurality of steps;
assigning a first vehicle to the initial step; and
moving the first vehicle to a first intermediate step based upon one or more of customer demand for the first vehicle, supply, and resources available to execute each of the at least two intermediate steps.

2. The method according to claim 1, further comprising generating an electronic alert message when the first vehicle is moved from the initial step to the first intermediate step.

3. The method according to claim 1, further comprising moving the first vehicle from the first intermediate step to a second intermediate step based upon one or more of customer demand for the first vehicle, supply, and resources available to execute each of the at least two intermediate steps.

4. The method according to claim 3, further comprising generating an electronic alert message when the first vehicle is moved from the first intermediate step to the second intermediate step.

5. The method according to claim 1, further comprising moving the first vehicle from the first intermediate step in the plurality of steps to all other intermediate steps in the at least two intermediate steps based upon one or more of customer demand for the first vehicle, supply, and resources available to execute each of the at least two intermediate steps.

6. The method according to claim 1, further comprising generating an electronic alert if the first vehicle remains in the first intermediate step longer than a threshold duration.

7. A method of optimizing cycle time for a process of preparing vehicles for sale, comprising:
defining a plurality of steps in a process of preparing vehicles for sale;
establishing an electronic database having a plurality of records, wherein each record comprises vehicle identification data and data regarding progress of the respective vehicle through the plurality of steps;
performing the plurality of steps upon a vehicle, wherein an order in which the plurality of steps are performed is based upon one or more of customer demand for the vehicle, supply, and resources available to execute each step within the plurality of steps.
